(19) United States
(12) Patent Application Publication
(10) Pub. No.: US 2020/0262546 A1
(43) Pub. Date: Aug. 20, 2020

(54) AERODYNAMIC ELEMENT PROVIDED WITH A CROSSFLOW CONTROL SYSTEM

(71) Applicant: Airbus Operations (S.A.S.), Toulouse (FR)

(72) Inventor: Mathias Farouz-Fouquet, Toulouse (FR)

(21) Appl. No.: 16/790,053

(22) Filed: Feb. 13, 2020

(30) Foreign Application Priority Data
Feb. 14, 2019 (FR) 1901511

(51) Int. Cl. B64C 23/00; H01T 23/00

(52) U.S. Cl. CPC B64C 23/005; H01T 23/00

(57) ABSTRACT

The aerodynamic element includes an ionization system which ionizes flow of air flowing over the top face of the aerodynamic element and a control system which generates at least one electromagnetic force associated with an electrical current and a magnetic field, the at least one electromagnetic force being oriented in the direction opposite to that of the flow of the ionized air flow such that the electromagnetic force reduces the instabilities of the flow of the airflow.

### CROSS-REFERENCE TO RELATED APPLICATION

This application claims the benefit of and priority to French patent application number 19 01511 filed on Feb. 14, 2019, the entire disclosure of which is incorporated by reference herein.

### TECHNICAL FIELD

The disclosure herein relates to an aerodynamic element for aircraft comprising a flow ionization system and a system for controlling the flow of the ionized air flow.

### BACKGROUND

Although not exclusively, the aerodynamic element can correspond to a wing of the aircraft, for example a transport airplane. It can also be another element (or surface) that is aerodynamic (tail unit, foil flap, etc.) of the aircraft, as specified hereinbelow.

In the case in particular of a so-called laminar wing of the aircraft, that is to say a wing that makes it possible to maintain a laminar flow over a significant distance, it is known that it is not generally possible to increase the sweep of the wing beyond 20° (at the leading edge of the wing).

A wing sweep beyond 20° at the leading edge in fact creates an instability of the crossflow, in particular for laminar wings where the pressure gradient is kept low, that is to say less than or equal to 0, over a long portion of the cord of the wing. This crossflow instability is the main limitation on increasing the wing sweep. This phenomenon is characterized by the appearance of a crossflow along the wing span, accompanied by vortices which move along the span of the wing. That prevents a laminar flow from being maintained. Now, an increase in the sweep would make it possible to increase the cruising flight speeds of the aircraft, without increasing the drag and the fuel consumption.

An object of the disclosure herein is to improve the conditions of flow over an aerodynamic element of an aircraft, such as a wing in order notably, in particular in the case of a wing of laminar type, to prevent the appearance of a crossflow instability even if the wing has a high sweep.

### SUMMARY

For this, it relates to an aerodynamic element comprising a first face over which flows an air flow and a second face opposite the first face.

According to the disclosure herein, the aerodynamic element comprises an ionization system configured to ionize the air flow being propagated over the first face and a control system configured to generate at least one electromagnetic force capable of modifying the flow of the air flow ionized by the ionization system, each of the at least one electromagnetic force being generated by an electrical current associated with a magnetic field.

Thus, by virtue of the disclosure herein, an aerodynamic element is obtained which is capable of generating one or more electromagnetic forces and of making the flow of the air flow sensitive to that or those electromagnetic forces. Furthermore as specified below, the electromagnetic force or forces generated are oriented in the direction opposite the crossflow. Consequently, it makes it possible to reduce the flow instabilities of the air flow, which contributes to improving the laminar flow flow conditions over the aerodynamic element.

Advantageously, the control system comprises:

a succession of electrical current conducting elements arranged parallel to one another on the first face, each of the conducting elements representing either a cathode or an anode, the succession of conducting elements forming an alternation of cathode and of anode, the succession of conducting elements being configured to cause a plurality of electrical currents to circulate, each of the electrical currents circulating from a cathode to an adjacent anode; and

a succession of magnetic elements arranged parallel to one another, on the second face, the succession of magnetic elements being configured to generate a magnetic field in a direction the to be radial to each interface between two successive magnetic elements, the series of magnetic fields being formed by an alternation of magnetic field oriented towards the first face and of magnetic field oriented towards the second face.

Moreover, in a first embodiment, each of the magnetic elements is a magnet formed in two parts, each of which parts is associated either with a north pole, or with a south pole, each of the magnetic fields being generated radially by bringing the parts of two adjacent magnets associated with identical poles into contact, a magnetic field being either oriented towards the first face if the parts in contact are associated with north poles, or oriented towards the second face if the parts in contact are associated with south poles.

Preferably, in this first embodiment, each of the magnets is produced in one of the following materials: samarium-cobalt, neodymium-iron-boron. Furthermore, in a second embodiment, each of the magnetic elements is a superconductor wire arranged in a sheath filled with nitrogen.

Moreover, advantageously, the ionization system comprises an electromagnetic wave generator and a plurality of waveguides arranged between the first and second faces, each of the waveguides being configured to propagate electromagnetic waves generated by the electromagnetic wave generator, each of the waveguides being provided with a plurality of holes, each of the holes being configured to diffuse a part of the electromagnetic waves, the part of the electromagnetic waves diffused by each of the holes ionizing the air flow flowing over the first face.

Furthermore, advantageously, the aerodynamic element comprises a dielectric material.

Preferably, the dielectric material is one of the following materials: polymer material, silicone or ceramic materials.

The disclosure herein relates also to an aircraft, in particular a transport airplane, which comprises at least one aerodynamic element, such as that described above.

### BRIEF DESCRIPTION OF THE DRAWINGS

The attached figures will give a good understanding of how the disclosure herein can be produced. In these figures, identical references denote similar elements.

FIG. 1 is a perspective schematic view of an aircraft to which the disclosure herein is applied.

FIG. 2 schematically illustrates a part of a wing of the aircraft in which the aerodynamic element according to a particular embodiment of the disclosure herein can be arranged.

FIG. 3 is a perspective view of a part of an aerodynamic element according to a particular embodiment of the disclosure herein.

FIG. 4A represents a first perspective diagram of the ionization and control systems of an aerodynamic element according to a particular embodiment of the disclosure herein.

FIG. 4B represents a second perspective diagram of the ionization and control systems of an aerodynamic element according to a particular embodiment of the disclosure herein.

FIG. 4C represents a third perspective diagram of the ionization and control systems of an aerodynamic element according to a particular embodiment of the disclosure herein.

### DETAILED DESCRIPTION

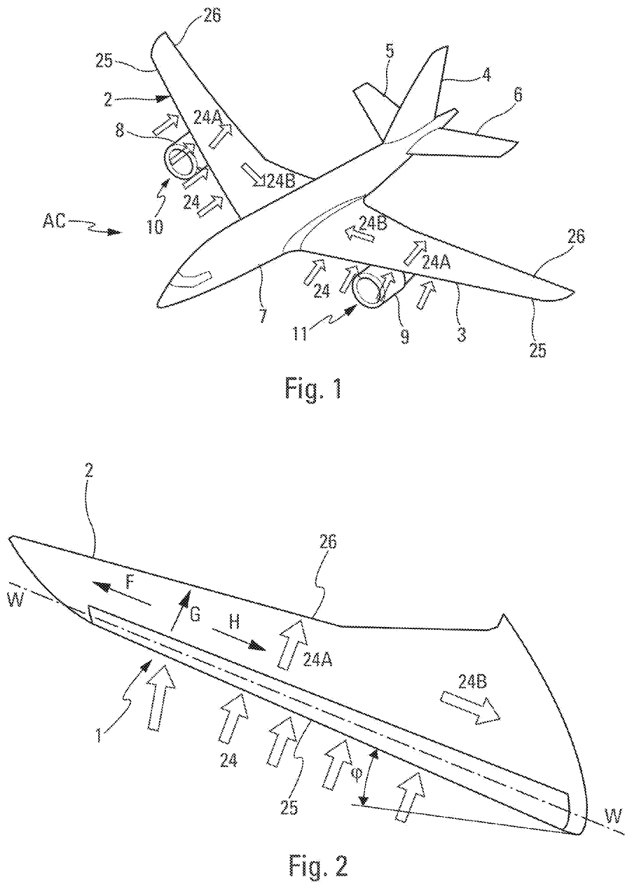

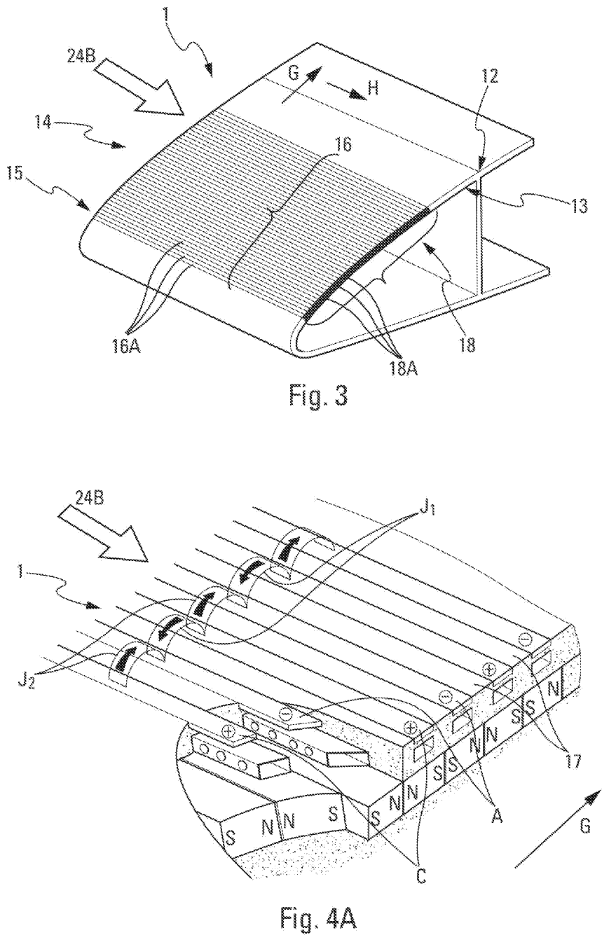

FIG. 1 schematically shows an aircraft AC, in particular a transport airplane, which is provided with at least one aerodynamic element 1 (not shown specifically), such as that represented in FIG. 3. In the context of the disclosure herein, the aerodynamic element 1 can correspond to at least a part of one of the following elements of the aircraft:

a wing 2,3;

a vertical tail unit 4;

a horizontal tail unit 5,6;

a part of fuselage 7;

a nacelle 8, 9 of an engine 10, 11; or

a foil flap (not represented).

By way of illustration (nonlimiting), the aerodynamic element 1 considered in the rest of the description corresponds to a part (or section) of one of the wings 2, 3 of the aircraft AC. In the example represented in FIG. 2, the aerodynamic element 1 is arranged along a so-called transverse axis W-W.

A wing with sweep greater than 20° generates air flow flow instabilities. As represented in FIGS. 1 and 2, the air flow 24 then comprises a laminar air flow 24A which flows from a leading edge 25 to a trailing edge 26 in the direction of an arrow G and a crossflow 24B which flows along the transverse axis W-W in a transverse direction, in the direction of an arrow H.

As represented in FIG. 3, the aerodynamic element 1 is provided with a first face, called top face 12, over which flows the air flow 24 and a second face, called bottom face 13. As an example, the thickness of the aerodynamic element 1, between the top face 12 and the bottom face 13, is approximately 10 millimeters.

In the context of the disclosure herein, the adjectives “bottom” and “top” are defined according to a radial direction relative to the transverse axis W-W, respectively towards the inside of the aerodynamic element 1 and towards the outside of the aerodynamic element 1.

According to the disclosure herein, the aerodynamic element 1 comprises an ionization system 14 configured to ionize the air flow 24 flowing over the top face 12 and a control system 15 which is configured to generate one or more electromagnetic forces F in the direction opposite to that of the arrow H (FIG. 2). This or these electromagnetic forces F are capable of modifying the flow of the air flow 24 ionized by the ionization system 14. An electromagnetic force F is generated by an electrical current associated with a magnetic field.

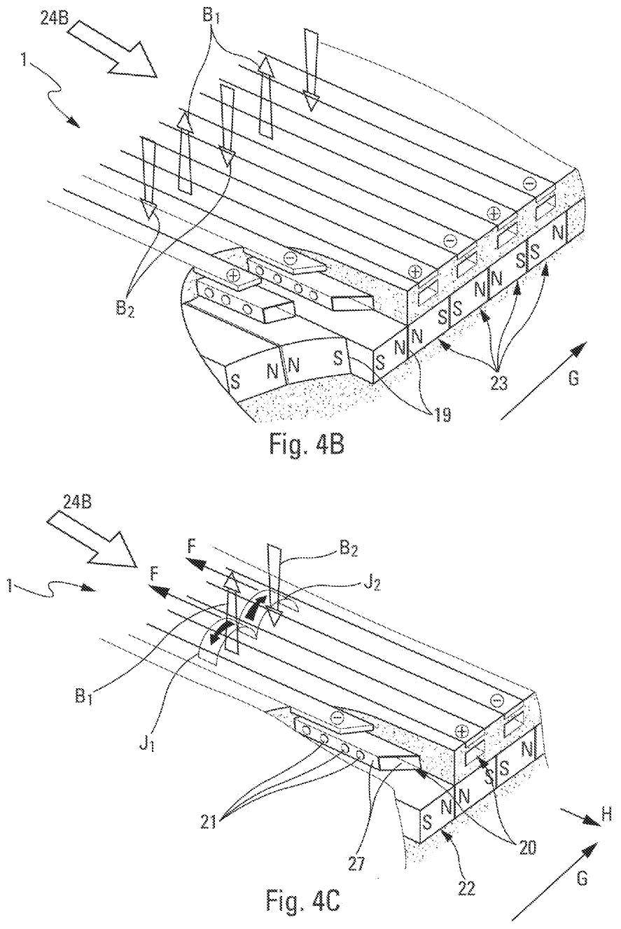

In a preferred embodiment, as represented in FIG. 3, the control system 15 comprises a succession 16 of electrical current conducting elements 16A (hereinafter “conducting elements”) which is configured to cause electrical currents J1, J2 to circulate (FIG. 4A).

As represented in FIG. 3, these conducting elements 16A are metallic plates of elongate form in the transverse direction. As an example, in the case of a wing 2, 3, the length of each of the conducting elements 16A (in the transverse direction) can represent the total length of a leading edge 25 of a wing 2, 3 of an aircraft AC. Furthermore, the succession 16 of conducting elements 16A can extend over a distance (in the longitudinal direction) that can represent up to 20% of the distance between the leading edge 25 and the trailing edge 26 of a wing 2, 3 of an aircraft AC.

Moreover, the conducting elements 16A are arranged parallel to one another on the top face 12 of the aerodynamic element 1, in the longitudinal direction. As represented in FIG. 4A, the conducting elements 16A are spaced apart from one another by a spacing 17. As an example, the spacing 17 lies between 1 and 5 millimeters. Each conducting element 16A has a width lying between 1 and 5 millimeters.

In a preferred embodiment, as represented in FIG. 4A, each of the conducting elements 16A is either a cathode C or an anode A. The conducting elements 16A are arranged so as to form an alternation of cathode C and of anode A.

Furthermore, each conducting element 16A is connected, either, if it is a cathode C, to a negative terminal, or, if it is an anode A, to a positive terminal of a direct current generator (not represented). In a particular embodiment, this direct current generator corresponds to an electrical current generator with which the engines 10, 11 of the aircraft AC are equipped. The direct current generator subjects each cathode C and each anode A which is adjacent to it to an electrical voltage. This electrical voltage generates an electrical current J1, J2 which circulates from a cathode C to an adjacent anode A, as represented in FIG. 4A. As an example, the electrical voltage is of the order of several thousands of volts.

As represented in FIG. 4A, the succession of a cathode C and of an anode A in the direction of the arrow G causes an electrical current J2 to circulate in the longitudinal direction in the direction of the arrow G. The succession of an anode A and of a cathode C in the direction of an arrow G causes an electrical current J1 to circulate in the longitudinal direction in the direction opposite to that of the arrow G.

The succession 16 of conducting elements 16A is therefore configured to cause electrical currents J1, J2 to circulate, alternately, in opposite directions. Moreover, the control system 15 also comprises a succession 18 of magnetic elements 18A. As represented in FIGS. 3 and 4B, the magnetic elements 18A are of of elongate form in the transverse direction. The magnetic elements 18A are arranged, on the bottom face 13, parallel to one another in the longitudinal direction. Furthermore, the magnetic elements 18A are in contact with one another. Each magnetic element 18A is located under a conducting element 16A in the radial direction. The width of a magnetic element 18A (in the longitudinal direction) is greater than the width of a conducting element 16A such that the interface 19 between two magnetic elements 18A in contact is located below the spacing 17 between two conducting elements 16A.

The successive magnetic elements 18A are configured to generate a magnetic field B1, B2 in the direction radial to each interface 19 between two magnetic elements 18A. The series of magnetic fields B1, B2 in the longitudinal direction corresponds to an alternation of magnetic field B1 oriented towards the top face 12 and of magnetic field B2 oriented towards the bottom face 13. The succession 16 of conducting elements 16A associated with the succession 18 of magnetic elements 18A therefore generate electromagnetic forces F oriented transversely in the direction opposite to the flow of the crossflow 24B according to the arrow H.

In a first preferred embodiment, the magnetic elements 18A are magnets 23 provided with a north pole N and a south pole S. As an example, these magnets 23 are produced in a samarium-cobalt alloy. They can also be produced in a neodymium-iron-boron alloy.

Moreover, as represented in FIG. 4B, each magnet 23 is formed by a front part and a rear part. Each pole N, S corresponds either to the front part, or to the rear part of the magnet.

In the context of the disclosure herein, the adjectives “front” and “rear” with respect to the aerodynamic element 1 are defined in the longitudinal direction, respectively in the direction of the arrow G and in the direction opposite to that of the arrow G.

As represented in FIG. 4B, a magnet 23 arranged under a cathode C is formed by a north pole N on its rear part and a south pole S on its front part. A magnet 23 arranged under an anode A is formed by a south pole S on its rear part and a north pole N on its front part.

Moreover, the magnets 23 are arranged parallel to one another in the longitudinal direction such that the front part of a magnet 23 provided with a south pole S (respectively a north pole N) is in contact with the rear part of a magnet 23 provided with a south pole S (respectively a north pole N). The contact of the front part of a magnet 23 and of the rear part of an adjacent magnet 23 provided with identical poles N, S generates, at the interface 19 between the magnets 23, a magnetic field B1, B2 in the radial direction. As represented in FIG. 4B, the magnetic field B1 generated at the interface 19 is oriented towards the top face 12 if the parts in contact are associated with north poles N. The magnetic field B2 generated at the interface is oriented towards the bottom face 13 if the parts in contact are associated with south poles S. The interface 19 between two magnets 23 is located under the spacing 17 between two conducting elements 16A. Consequently, each generated magnetic field B1, B2, whatever its orientation, radially crosses the spacing 17 between two conducting elements 16A.

As represented in FIG. 4C, the magnetic field B1 oriented radially towards the top face 12 is associated with the current J1 circulating in the direction opposite to that of the arrow G in the spacing 17 which generates an electromagnetic force F oriented in the direction opposite to that of the arrow H.

A magnetic field B2 oriented radially towards the bottom face 13 is associated with the current J2 circulating in the direction of the arrow G in the spacing 17 which generates an electromagnetic force F oriented in the direction opposite to that of the arrow H.

In a variant, the magnetic elements 18A are produced in high-critical-temperature superconducting materials (not represented). These high-critical-temperature superconducting materials (hereinafter called “superconductor”) develop particular magnetic properties when their temperature is below a critical temperature. As an example, a superconductor of cuprate type has a critical temperature of approximately -135 degrees Celsius.

The superconductors are of elongate form in the transverse direction and are arranged in sheaths (not represented). Each sheath is filled with liquid nitrogen to keep the superconductor at a temperature below its critical temperature. At temperatures below their critical temperature, the superconductors are capable of generating, at each interface between two sheaths, an alternation of magnetic field B1 oriented towards the top face 12 and of magnetic field B2 oriented towards the bottom face 13.

In a preferred embodiment, the ionization system 14 comprises an electromagnetic wave generator (not represented). As an example, the electromagnetic waves generated by the electromagnetic wave generator are microwaves. The frequency of these microwaves is approximately 2.45 Gigahertz.

Moreover, the ionization system 14 also comprises a plurality of waveguides 20 which are configured to propagate, in the transverse direction, the electromagnetic waves generated by the electromagnetic wave generator. These waveguides 20 are formed by elongate tubes in the transverse direction and arranged parallel to one another in the longitudinal direction. In a preferred embodiment, the waveguides 20 are of rectangular section, as represented in FIG. 4C. In a variant, they are of square section.

Moreover, each waveguide 20 is arranged between a conducting element 16A and a magnetic element 18A. Each waveguide 20 has a width in the longitudinal direction which is substantially equal to the width of a conducting element 16A.

In a preferred embodiment, the waveguides 20 are provided with a plurality of holes 21. The holes 21 are arranged along (in the transverse direction) the faces 27 of a waveguide 20 which extend in the transverse and radial directions. Each of the holes 21 is configured to diffuse a part of the electromagnetic waves between the waveguides 20. The diffused part of the electromagnetic waves (hereinafter called “diffused part”) is capable of being propagated in all directions, notably in the radial direction across the spacing 17 between two conducting elements 16A. On contact with the diffused part, the air flow 24 flowing over the top face 12 is ionized. The ionized air flow 24 comprises cations which are elements carrying a positive electrical charge and anions which are elements carrying a negative electrical charge. These cations and these anions are sensitive to an electromagnetic force F.

In a preferred embodiment, the aerodynamic element 1, in which the control system 15 and the ionization system 14 are arranged, comprises a dielectric material 22. This dielectric material 22 is configured to electrically insulate the waveguides 20, from the magnetic elements 18A and from the conducting elements 16A. The dielectric material 22 is therefore present between each waveguide 20. The dielectric material can be one of the following materials: polymer material, ceramic material, silicone.

An example of operation of an aerodynamic element 1 is presented hereinbelow, with reference to FIG. 4C.

The air flow 24 flowing over the top face 12 of the aerodynamic element 1 comprises a laminar air flow 24A which flows longitudinally in the direction of the arrow G, and a crossflow 24B. This crossflow 24B corresponds to vortices which move in the transverse direction in the direction of the arrow H. The crossflow 24B can become unstable and generate turbulent vortices. These turbulent vortices can cause notably a loss of adhesion of the air flow on a wing 2, 3.

The electromagnetic wave generator generates microwaves at a frequency of 2.45 Gigahertz. The microwaves are propagated in the waveguides 20 in the transverse direction. A part of the microwaves is diffused through the holes 21 arranged on the transverse faces 27 of the waveguides 20. The holes 21 are distributed over all the length of the waveguides 20 in the transverse direction so that the part of the waveguides is diffused over all the length of the aerodynamic element 1. The diffused part can be propagated in all the directions, notably in the radial direction, through the spacing 17.

The diffused part is then in contact with the laminar air flow 24A and the crossflow 24B present at the spacing. The laminar air flow 24A and crossflow 24B are then ionized. Once ionized, they are formed by anions, that is to say elements of which the electrical charge is negative, and cations, that is to say elements of which the electrical charge is positive.

The spatial configuration of the control system 15 makes only ionized crossflow 24B sensitive to the electromagnetic force or forces generated. Thus, the cations, respectively the anions, forming the crossflow 24B, are displaced in the direction of the arrow H but also to the closest anode A, respectively cathode C.

As represented in FIG. 4C, the cations of the crossflow 24B are directed towards an anode A by following the current J1 oriented in the direction opposite to that of the arrow G, whereas the anions are directed towards a cathode C by following the opposite direction to the current J1. The cations and the anions are therefore deflected in opposite directions.

The cations, respectively the anions, are subjected to the magnetic field B1 which deflects their trajectory radially towards the top face 12, respectively towards the bottom face 13. Although the current J1 and the magnetic field B1 deflect the cations and the anions of the ionized crossflow 24B in opposite directions, their association generates the electromagnetic force F. This electromagnetic force F is oriented in the direction opposite to the flow of the cations and of the anions of the crossflow 24B such that they can no longer be displaced.

Cations of the crossflow 24B can also be directed towards an anode A by following the current J2 which is oriented in the direction of the arrow G. Anions of the crossflow 24B can be displaced towards a cathode C by following the opposite direction of the current J2. The cations are therefore deflected in the direction of the arrow G and the anions are deflected in the direction opposite to that of the arrow G. The magnetic field B2 to which the cations, respectively the anions, are subjected, also deflects their trajectory in the direction of the bottom face 13, respectively, in the direction of the top face 12. The cations and the anions are therefore deflected in opposite directions by the current J2 and by the magnetic field B2. The association of the current J2 and of the magnetic field B2 generates the electromagnetic force F oriented in the direction opposite to the flow of the cations and of the anions of the crossflow 24B.

The ionized crossflow 24B is entirely subjected to electromagnetic forces F. These electromagnetic forces F act in the direction opposite to that of the flow of the crossflow 24B such that the latter disappears.

The aerodynamic element 1, as described above, offers numerous advantages. In particular:

it makes it possible to maintain a laminar flow on top of a wing 2, 3 which has a sweep φ (FIG. 2) of leading edge 25, greater than 20°,

it allows for higher cruising speeds for the aircraft AC,

it makes it possible to provide laminar flows on the wings 2, 3 of long-haul airplanes;

it allows for a reduction of the drag even at Mach numbers above 0.77, and thus for a reduction of fuel consumption;

it can prevent the formation of ice on its surface;

it can accommodate one or more other systems in its internal volume; and

it generates substantially no additional weight.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aerodynamic element comprising:
a first face configured for a flow of air to flow over the first face;
a second face opposite the first face;
an ionization system configured to ionize flow of air propagated over the first face; and
a control system configured to generate at least one electromagnetic force in a direction opposite to a direction of the flow of air and configured to modify the flow of the flow of air ionized by the ionization system, each of the at least one electromagnetic force being generated by an electrical current associated with a magnetic field.

2. The aerodynamic element according to claim 1, wherein the control system comprises:
a succession of electrical current conducting elements that are parallel to one another on the first face, each of the conducting elements representing either a cathode or an anode, the succession of conducting elements forming an alternation of cathode and anode, the succession of conducting elements being configured to cause a plurality of electrical currents to circulate, each of the electrical currents circulating from a cathode to an adjacent anode; and
a succession of magnetic elements that are parallel to one another, on the second face, the succession of magnetic elements being configured to generate a magnetic field in a direction the to be radial to each interface between two successive magnetic elements, the series of magnetic fields being formed by an alternation of magnetic field oriented towards the first face and of magnetic field oriented towards the second face.

3. The aerodynamic element according to claim 2, wherein each of the magnetic elements is a magnet formed in two parts, wherein each of the parts is associated either with a north pole or with a south pole, each magnetic field being generated radially by bringing the parts of two adjacent magnets associated with identical poles into contact, a magnetic field being either oriented towards the first face if the parts in contact are associated with north poles, or oriented towards the second face if the parts in contact are associated with south poles.

4. The aerodynamic element according to claim 3, wherein each of the magnets is produced in one of: samarium-cobalt, neodymium-iron-boron.

5. The aerodynamic element according to claim 1, wherein each of the magnetic elements is a superconductor in a sheath.

6. The aerodynamic element according to claim 1, wherein the ionization system comprises an electromagnetic wave generator and a plurality of waveguides between the first face and second face, each of the waveguides configured to propagate electromagnetic waves generated by the electromagnetic wave generator, each of the waveguides comprising a plurality of holes, each of the holes being configured to diffuse a part of the electromagnetic waves, the part of the electromagnetic waves diffused by each of the holes ionizing the air flow flowing over the first face.

7. The aerodynamic element according to claim 1, comprising a dielectric material.

8. The aerodynamic element according to claim 7, wherein the dielectric material is selected from the group consisting of polymer material, silicone and ceramic materials.

9. An aircraft comprising at least one aerodynamic element that comprises:
a first face configured for a flow of air to flow over the first face;
a second face opposite the first face;
an ionization system configured to ionize flow of air propagated over the first face; and
a control system configured to generate at least one electromagnetic force in a direction opposite to a direction of the flow of air and configured to modify the flow of the flow of air ionized by the ionization system, each of the at least one electromagnetic force being generated by an electrical current associated with a magnetic field.
